(19) United States
(12) Patent Application Publication
(10) Pub. No.: US 2025/0181972 A1
(43) Pub. Date: Jun. 5, 2025

(54) FINE-TUNING OF TRANSDUCTIVE FEW-SHOT LEARNING METHODS USING MARGIN-BASED UNCERTAINTY WEIGHTING AND PROBABILITY REGULARIZATION

(71) Applicant: CARNEGIE MELLON UNIVERSITY, Pittsburgh, PA (US)

(72) Inventors: MARIOS SAVVIDES, Pittsburgh, PA (US); RAN TAO, Pittsburgh, PA (US); HAO CHEN, Pittsburgh, PA (US)

(73) Assignee: CARNEGIE MELLON UNIVERSITY, Pittsburgh, PA (US)

(21) Appl. No.: 18/868,074

(22) PCT Filed: Aug. 9, 2023
(86) PCT No.: PCT/US23/29854

§ 371 Date: Nov. 21, 2024

Related U.S. Application Data
(60) Provisional application No. 63/396,655, filed on Aug. 10, 2022.

(51) Int. Cl. G06N 20/00

(52) U.S. Cl. CPC G06N 20/00

(57) ABSTRACT

Disclosed herein is a novel method for improving transductive fine-tuning for few-shot learning using margin-based uncertainty weighting and probability regularization. Margin-based uncertainty is designed to assign low loss weights for wrongly predicted samples and high loss weights for the correct ones. Probability regularization provides for the probability of each testing sample being adjusted by a scale vector, which quantifies the difference between the class marginal distribution and the uniform.

### RELATED APPLICATIONS

This application is a non-provisional of, and claims the benefit of U.S. Provisional Patent Applications No. 63/396,655, filed Aug. 10, 2022, entitled “Transductive Few-Shot Classification With Decisive Weighting and Fairness Scaling”, the contents of which are incorporated herein in their entirety.

### GOVERNMENT INTEREST

This invention was made with United States Government support under contract AW911NF20D0002 awarded by the U.S. Army. The U.S. Government has certain rights in the invention.

### BACKGROUND

Deep learning has gained vital progress in various architecture designs, optimization techniques, data augmentation, and learning strategies and has demonstrated great potential in applications to real-world scenarios. However, applications with deep learning generally require a large amount of labeled data, which is time-consuming to collect and costly on manual labeling force.

Few-shot learning (FSL) is a machine Learning framework that enables a pre-trained model to generalize over new categories of data not seen during training and using only a few labeled samples per class. FSL becomes increasingly essential to significantly alleviate the dependence on data acquisition. Recent attention on FSL over out-of-distribution datum poses a challenge in obtaining efficient algorithms that can perform well on cross-domain situations. Finetuning a pre-trained feature extractor with a few samples has the potential to solve this challenge.

However, a few training samples leads to a biased estimation of the true data distribution. The biased learning during few-shot fine-tuning could further mislead the model to learn an imbalanced class marginal distribution. To verify this, the largest difference (LD) between the number of per-class predictions with a uniform testing set is quantified. If the fine-tuned model learns a balanced class marginal distribution, with a uniform testing set, LD should approach zero. However, empirical results show the opposite. As shown in FIG. 1, even with prior art methods, LD could be significantly over 10 in practice. The fine-tuned models in FSL suffer from severely imbalanced categorical performance. In other words, the learned class marginal distribution of few-shot fine-tuned models is largely imbalanced and biased. Solving this issue is critical to maintaining the algorithm's robustness to different testing scenarios. Classes with fewer predictions would carry low accuracy, and this issue of fine-tuned models could yield a fatal failure for testing scenarios in favor of these classes.

FIG. 1 shows that fine-tuned models with current state-of-the-art methods learned an imbalanced class marginal distribution. In the empirical experiments, a uniform testing set is utilized, and the Largest Difference LD between per-class predictions is used to quantify whether the learned class marginal probability is balanced. Data are from sub-datasets in Meta-Dataset with 100 episodes for each dataset and 10 per-class testing samples. With prior art methods, LD is over 10.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Disclosed herein is a method providing an improvement to transductive fine-tuning for few-shot learning which effectively uses unlabeled testing data. The imbalanced categorical performance in FSL motivates two solutions.

The first solution uses per-sample loss weighting through margin-based uncertainty. As shown in FIG. 2, for per-sample loss weighting, using the same number of per-class training data achieves extremely imbalanced prediction results. It indicates that each sample contributes to the final performance differently. Therefore, the unlabeled testing samples are weighted according to their uncertainty scores. The use of margin in the entropy computation is disclosed to compress the utilization of wrong predictions.

The second solution is probability regularization. As the ideal performance should be categorically balanced, the probability for each testing data is explicitly regularized. Precisely, the categorical probability of each testing sample is adjusted by a scale vector, which quantifies the difference between the class marginal distribution and the uniform. The class marginal distribution is estimated by combining each query sample with the complete support set.

The method for improving the fine-tuning of transductive few-shot learning using margin-based uncertainty weighting and probability regularization (TF-MP) effectively reduces the largest difference between per-class predictions by around 5 samples and further improves per-class accuracy approximately 2.1%. This is shown in FIG. 1. Meanwhile, TF-MP shows robust cross-domain performance boosts on Meta-Dataset, demonstrating its potential in real applications.

There are thus two novel aspects disclosed herein for improving transductive fine-tuning. These are utilizing margin-based uncertainty to weigh each unlabeled testing data in the loss objective to compress the utilization of possibly wrong predictions and regularizing the categorical probability for each testing sample to pursue a more balanced class marginal during finetuning.

FIG. 2 is an illustration of TF-MP. The results of a 1-shot 10-way classification is empirically evaluated on the correct/predicted number of per-class predictions. The model without TF-MP presents a severely imbalanced categorical performance even with the same number of per-class training samples. Using the margin-based uncertainty disclosed herein, the loss of each unlabeled testing data is weighted during finetuning, compressing the utilization of wrongly predicted testing data.

The categorical probability for each testing data is regularized to pursue balanced class-wise learning during finetuning. Using TF-MP, the difference between per-class predictions reduces from 21.3% to 14.4% with per-class accuracy improved from 4.5% to 4.9%. Results are averaged over 100 episodes in the meta-dataset.

### BRIEF DESCRIPTION OF THE DRAWINGS

By way of example, specific exemplary embodiments of the disclosed systems and methods will now be described, with reference to the accompanying drawings, in which:

FIG. 1 is a graph showing the largest difference between the number of per-class predictions with a uniform testing set for prior art methods and the method of the present invention.

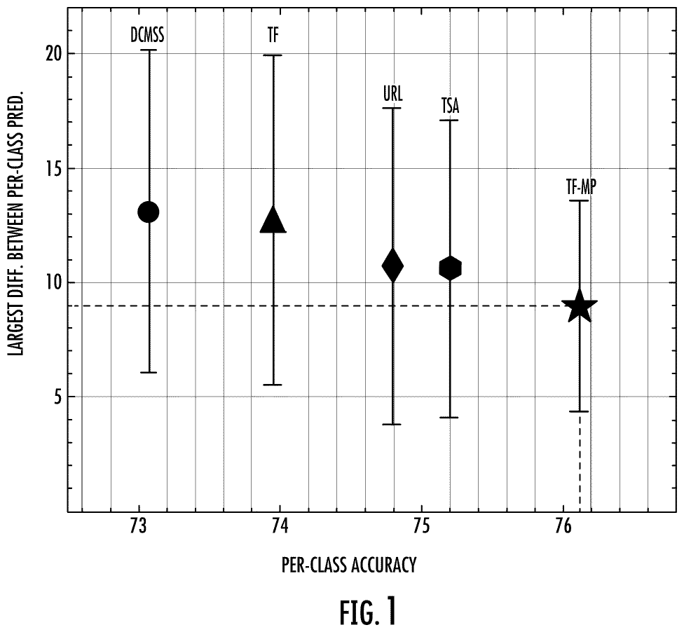

FIG. 2 are graphs illustrating the benefit of eth disclosed methods.

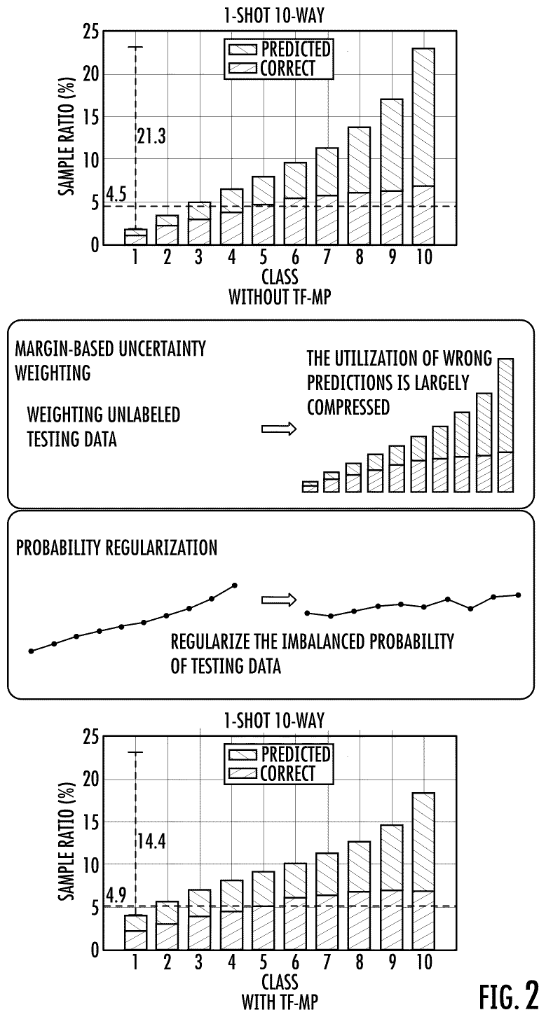

FIG. 3 are graphs showing a 3-class illustration of uncertainty scores computed by both margin-based entropy and regular entropy.

### DETAILED DESCRIPTION

Transductive few shot learning uses the unlabeled query set (testing images) along with the support set (training images) to make up for the lack of training data. Disclosed herein is a framework for performing transductive fine tuning and a disclosure of TF-MP.

First, the terminology and episode setting in FSL will be formally described. For one episode in FSL, the training and testing set is referred to as the support and query set, respectively. Let (x, y) denote the pair of an input x with its ground-truth one-hot label y∈ [symbol] , where C is the number of classes. The support set is then represented as [symbol] ={(xᵢ, yᵢ)}ᵢ₌₁^{N}^{ₛ}. The query set is denoted as [symbol] q={(xᵢ)}ᵢ₌₁^{N}^{_{q}} where the ground-truth labels are unknown if used in a transductive manner and Nₛ and N_{q} are the total number of samples in support set and query set, respectively.

A feature extractor f_{θ} is first pre-trained on a meta-training dataset, and transductive fine-tuning is conducted on the meta-test dataset within each episode. We denote p_{θ}(y|x) as the categorical probabilities on C classes, which is the output from the softmax layer in the model:

$${p}_{θ} ( y = c \vert x ) = \frac{{e}^{{z}_{c}}}{{\sum }_{i = 1}^{C} {e}^{{z}_{i}}} \qquad ( 1 )$$

where:
zᵢ= [symbol] wᵢ, f_{θ}(x) [symbol] ;
i∈C; and
the dot product between wᵢ and f_{θ}(x) is the logit for class i.

wᵢ is the novel class prototype that is initialized as the mean feature from the support set [symbol] ₛ for every iteration. A model with parameter θ is learned to classify [symbol] ₛ and [symbol] _{q} as measured by the following criterion:

$${θ}^{*} ( {𝒟}_{s} , {𝒟}_{q} ) = arg {min}_{θ} ( \frac{1}{{N}_{s}} {\sum }_{( x , y ) ∈ {𝒟}_{q}} {ℒ}_{s} ( x , y ) + \frac{1}{{N}_{q}} {\sum }_{( x ) ∈ {𝒟}_{q}} {ℒ}_{q} ( x ) ) \qquad ( 2 )$$

The loss [symbol] ₛ(x, y) for the labeled support set is the cross entropy loss and the loss [symbol] _{q}(x) for the unlabeled query set is constructed as entropy minimization:

$${ℒ}_{q} ( x ) = λ ( {p}_{θ} ( y \vert x ) ) \times H ( {p}_{θ} ( y \vert x ) ) \qquad ( 3 )$$

where:
λ denotes the per-sample loss weight; and
H(p_{θ}(y|x))=−p_{θ}(y|x) log(p_{θ}(y|x)) is the entropy loss.

Specifically, the entropy loss for unsupervised data can be generally represented as H(p_{θ}(y|x))=−ŷlog(p_{θ}(y|x)). As widely used in semi-supervised learning, there are two types of ŷ: when ŷ=argmax(p_{θ}(y|x)) it is referred to as pseudo-label, whereas when ŷ=p_{θ}(y|x), it is noted as soft-label.

In prior art transductive fine-tuning, soft-label is utilized with λ=1 for every testing image, and the entropy minimization is conducted on the logit space. Different from the prior art, [symbol] _{q}(x) is directly optimized on the feature space and λ(p_{θ}(y|x)) is designed to compress the utilization of wrong predictions. Probability regularization is applied on p_{θ}(y|x) before forwarding it to H(p_{θ}(y|x)).

### Margin-Based Uncertainty Weighting

Margin-based uncertainty is designed to assign low loss weights for wrongly predicted samples and high loss weights for the correct ones. However, the generally used entropy-based weighting may not truly reflect whether the sample has the wrong prediction. Furthermore, margin-based uncertainty weighting is used to compress the utilization of wrongly predicted testing data.

The class with the maximum probability pₘₐₓ is assigned as the predicted class. Thus, pₘₐₓ is referred to as the confidence, which indicates the confidence level of the categorical prediction. The other index used to indicate the confidence level of the prediction is the entropy of the predicted probabilities. In semi-supervised learning, an entropy-based per-sample loss weight is used as:

$$λ ( P ) = 1 - e ( P ) \qquad ( 4 )$$

where:
P=p_{θ}(y|x); and
e(P) refers to the normalized entropy:

$$e ( P ) = - \frac{{\sum }_{i}^{C} ( {p}_{i} , log {p}_{i} )}{log C} \qquad ( 5 )$$

where:
Σᵢ^{C}pᵢ=1;
P=[p₁, p₂, . . . , p_{C}]; and
C is the number of classes.

e(P) is normalized to [0,1] as the entropy Σᵢ^{C}(pᵢ, log pᵢ) is scaled by its maximum value log C. Entropy on p(y|x) quantifies the uncertainty of probabilities. Larger uncertainty generally refers to a lower confidence level the sample carries towards its class prediction, consequently leading to lower loss weight λ(P). However, Eq. (5) indicates that the uncertainty on the whole probability distribution may not be ideal for distinguishing whether the predictions are wrong.

Intuitively, wrong predictions are more likely to be made when the model produces similar probabilities between two classes. In other words, the margin between the maximum and second maximum probability Δp can largely reflect how uncertain an example is with its prediction. A smaller margin indicates larger uncertainty on the prediction, which indicates a higher possibility that the prediction is wrong.

Margin information is reflected in the entropy-based uncertainty measurement. When pₘₐₓ is fixed, the margin Δp is in the range of:

$$min ( Δ p ) = {p}_{max} - ( 1 - {p}_{max} ) , max ( Δ p ) = {p}_{max} - \frac{1 - {p}_{max}}{c - 1} .$$

Samples with the largest margin (Δp)ₘₐₓ are expected to be assigned with the least uncertainty on decisions. However, the entropy score gives the opposite answer. For max(Δp), the entropy is:

$${e}_{max ( Δ p )} = {e}_{min ( Δ p )} + \frac{( 1 - {p}_{max} ) log ( c - 1 )}{log c} \qquad ( 6 )$$

### As

$$\frac{( 1 - {p}_{max} ) log ( c - 1 )}{log c}$$

is non-negative, Eq. (6) reveals that samples with largest margin max(Δp) carry larger entropy-based uncertainty scores than samples with min(Δp), which is contradictory to the information implied by the margin.

To solve this contradiction, it is important to use only top-2 probabilities in Eq. (5). The maximum and second maximum probabilities are first normalized by dividing the sum to satisfy the requirement of Σᵢ^{c}pᵢ=1 in Eq. (5). \hat{p}ₘₐₓ and Δ\hat{p} are referred to as the normalized results, which are further used in Eq. (7). The margin-based uncertainty is defined as:

$$\hat{e} ( P ) = - \frac{1}{log 2} ( {\hat{p}}_{max} log {\hat{p}}_{max} + ( {\hat{p}}_{max} - Δ \hat{p} ) log ( {\hat{p}}_{max} - Δ \hat{p} ) ) \qquad ( 7 )$$

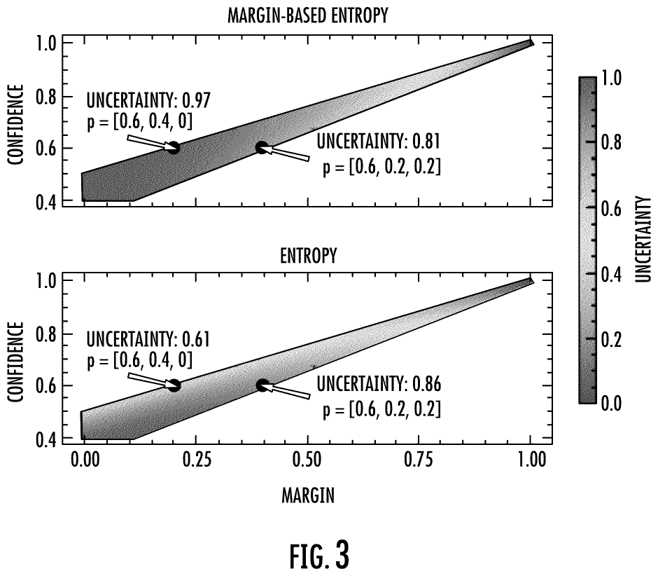

This modification unifies the information carried by confidence, margin, and entropy. When margin Δ\hat{p} is fixed, ê(P) is non-decreasing with confidence \hat{p}ₘₐₓ. When confidence \hat{p}ₘₐₓ is fixed, ê(P) is non-decreasing with Δ\hat{p} as well. In doing so, the margin-based entropy score could consistently reflect the confidence level pₘₐₓ as well as the margin Δp, as shown in FIG. 3. By focusing on the uncertainty delivered by the margin in P, it achieves more substantial compression on utilization of wrong predictions compared with entropy-based loss weights.

FIG. 3 shows a 3-class illustration of uncertainty scores computed by both margin-based entropy and entropy. The change in uncertainty scores with respect to confidence and margin are plotted. Entropy assigns lower uncertainty scores over the minimum margin area (lighter red), while margin-based entropy assigns uncertainty scores consistent with the information conveyed by confidence and margin: higher uncertainty scores (darker red) over the low confidence (0.4-0.5) and small margin areas. Compared with entropy, margin-based entropy increases the uncertainty score of p=[0.6, 0.4, 0] (margin=0.2) from 0.61 to 0.98 and decreases the uncertainty score of p=[0.6, 0.2, 0.2] (margin=0.4) from 0.86 to 0.81.

### Probability Regularization

As previously discussed, the learned class marginal distribution from a few-shot fine-tuned model is severally imbalanced. Therefore, the importance of explicitly regularizing the categorical probability for each testing sample, as will now be disclosed, is emphasized.

The probability regularization is explicitly conducted on the predicted probability p(y|x) for each testing data. First, with x∈ [symbol] _{q}, the learned class marginal distribution is estimated using the set x∪ [symbol] ₛ, which is constructed by combining each testing data with the whole support set. A unique scale vector v∈ [symbol] is obtained for each testing sample by aligning the estimated marginal probability with a uniform prior:

$$v = \frac{U}{{\hat{E}}_{x ⋃ {𝒟}_{s}} [ {p}_{θ} ( y \vert x ) ]} \qquad ( 8 )$$

where:
U∈ [symbol] represents the uniform prior; and
v is a scale vector quantifying the difference between estimated marginal distribution with the uniform prior.

Furthermore, v is used to conduct probability regularization on q=p_{θ}(y|x) as:

$$\tilde{q} = Normalize ( q * v ) \qquad ( 9 )$$

where:

$$Normalize ( {x}_{i} ) = \frac{{x}_{i}}{{\sum }_{j} {x}_{j}} ;$$

and
* denotes element-wise multiplication.

(q*v) applies re-scaling on q to reduce the difference between estimated marginal distribution with the uniform prior.

In doing so, each sample from the query set obtains a unique scale vector v, which allows per-sample probability regularization. Meanwhile, aligning the estimated marginal probability of x∪ [symbol] ₛ to uniform avoids direct regularization on the class marginal probability of the whole query set. This allows the probability regularization to be theoretically effective when the actual testing set is not uniform. The uniform prior serves as a solid regularization to enforce the class balance during fine-tuning.

By solving the issue of class-imbalanced predictions in few-shot learning, TF-MP enhances real-world few-shot applications. The margin-based uncertainty weighting provides a better measurement of the uncertainty in predictions with theoretical and empirical analysis.

As would be realized by one of skill in the art, many variations in the designs discussed herein fall within the intended scope of the invention. Moreover, it is to be understood that the features of the various embodiments described herein are not mutually exclusive and can exist in various combinations and permutations, even if such combinations or permutations were not made express herein, without departing from the spirit and scope of the invention. Accordingly, the method and system disclosed herein are not to be taken as limitations on the invention but as an illustration thereof. The scope of the invention is defined by the claims which follow.

1. A method of improving few shot learning for a machine learning model comprising:
pretraining a feature extractor of the machine learning model on a training dataset
performing transductive fine-tuning of the machine learning model using a test dataset;
training the model on a new class having few samples;
predicting a probability of a correct classification for each class for each sample;
wherein wrongly-predicted samples from the new class are assigned low loss weights and correctly-predicted samples from the new class are assigned high loss weights.

2. The method of claim 1 wherein the assigned per-sample loss weights are entropy-based.

3. The method of claim 2 wherein the entropy quantifies an uncertainty of a probability of a correct prediction for the sample, wherein larger uncertainties implies a lower confidence level, resulting in a lower loss weight for the sample.

4. The method of claim 2 further comprising:
determining a margin between probabilities for two classes for each sample;
wherein the two classes are the classes having the highest and second-highest probability of a correct prediction for the sample.

5. The method of claim 4 wherein a smaller margin indicates a larger uncertainty of a correct prediction for the sample.

6. The method of claim 4 wherein the highest and second highest probabilities are normalized.

7. The method of claim 6 wherein the entropy-based loss weight is a function of the margin for each sample.

8. The method of claim 7 further comprising:
regularizing the probabilities for each testing sample.

9. The method of claim 8 further comprising:
obtaining a scale vector for each testing sample.

10. The method of claim 9 wherein each scale vector is quantified as a difference between an estimated marginal probability and a uniform prior.

11. The method of claim 10 further comprising:
applying the scale vector to the probabilities for each sample.

12. The method of claim 11 wherein the scale vector is applied by an element-wise multiplication with a probability vector.
